(19) United States
(12) Patent Application Publication
(10) Pub. No.: US 2013/0051881 A1
(43) Pub. Date: Feb. 28, 2013

(54) COMBINED WASTE COLLECTION AND TONING STATION

(71) Applicants: Jeffrey A. Pitas, Macedon, NY (US); Alan E. Rapkin, Pittsford, NY (US)

(72) Inventors: Jeffrey A. Pitas, Macedon, NY (US); Alan E. Rapkin, Pittsford, NY (US)

(21) Appl. No.: 13/214,483

(22) Filed: Aug. 22, 2011

(51) Int. Cl. G03G 21/00; G03G 21/12

(52) U.S. Cl. 399/358; 399/360

(57) ABSTRACT

An apparatus for collecting electrophotographic waste includes a toning station containing fresh toner; an auger for transferring waste toner to the toning station; and a member or membrane for separating waste toner in the toner bottle from fresh toner.

### CROSS REFERENCE TO RELATED APPLICATIONS

Reference is made to commonly-assigned copending U.S. patent application Ser. No. 12/872,244, filed Aug. 31, 2010, entitled APPARATUS FOR COLLECTING ELECTROPHOTOGRAPHIC WASTE, by Pitas et al.; the disclosure of which is incorporated herein.

### FIELD OF THE INVENTION

This invention relates in general to electrophotographic printing and in particular to collecting electrophotographic waste.

### BACKGROUND OF THE INVENTION

The electrophotographic process creates an image on paper or other suitable printing media. The electrophotographic process uses various components assembled into a print engine to enable printing. The primary material used for printing purposes is toner.

During the printing process only a portion of the toner transfers to the print media. Some of this toner may be unsuitable for transfer, but is present in the toner supply, or some of the toner may be discarded as part of the normal printing process. Considering the quantity of waste toner produced by the print engine and the life of the print engine, it may be impractical to store this material for a long period of time within the print engine. Therefore a practical means of elimination of waste toner is needed, while minimizing maintenance required by the end user.

### SUMMARY OF THE INVENTION

Briefly, according to one aspect of the present invention an apparatus for collecting electrophotographic waste includes a toning station containing fresh toner; an auger for transferring waste toner to the toning station; and a member or membrane for separating waste toner in the toner bottle from fresh toner.

The invention and its objects and advantages will become more apparent in the detailed description of the preferred embodiment presented below.

### BRIEF DESCRIPTION OF THE DRAWINGS

FIG. 1 is a schematic of an electrophotographic printer.

FIG. 2 is a schematic of a replacement cartridge for an electrophotographic printer.

FIG. 3 is a schematic of a toning unit sump and waste collection system

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

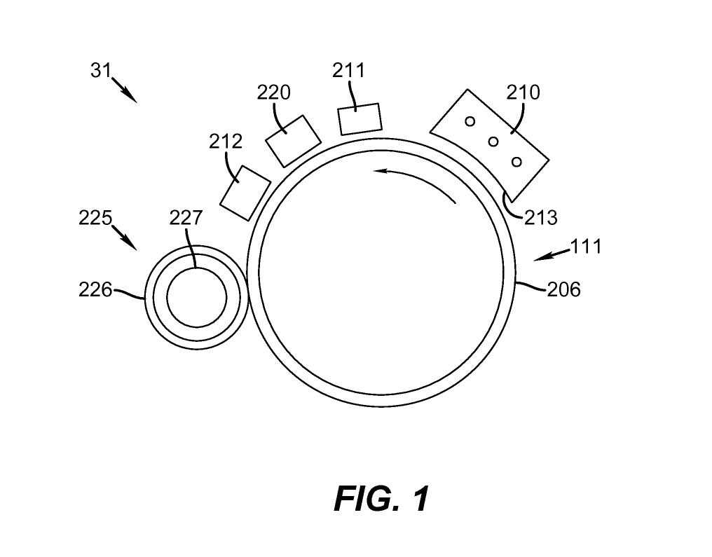

Referring now to FIG. 1 an electrophotographic printer includes all components necessary to accomplish the task of printing an image on paper. A printer is comprised of various sub-assemblies which perform specific functions.

An imaging module in the printer consists of components to enable printing of a single color image. Multiple modules may be assembled to enable the printing of multiple color images. FIG. 1 shows details of a typical printing module 31, which may be assembled with other imaging modules to enable the printing of multiple colors.

Primary charging subsystem 210 uniformly electrostatically charges photoreceptor 206 of photoreceptive member 111, which is shown in the form of an imaging cylinder. Charging subsystem 210 may include a grid 213 having a selected voltage, or may be in the form of a roller with conductive properties.

Additional components provided for control may be assembled around the various process elements of the respective printing modules. Meter 211 measures the uniform electrostatic charge provided by charging subsystem 210 and meter 212 measures the post-exposure surface potential within a patch area of a latent image formed from time to time in a non-image area on photoreceptive member 206.

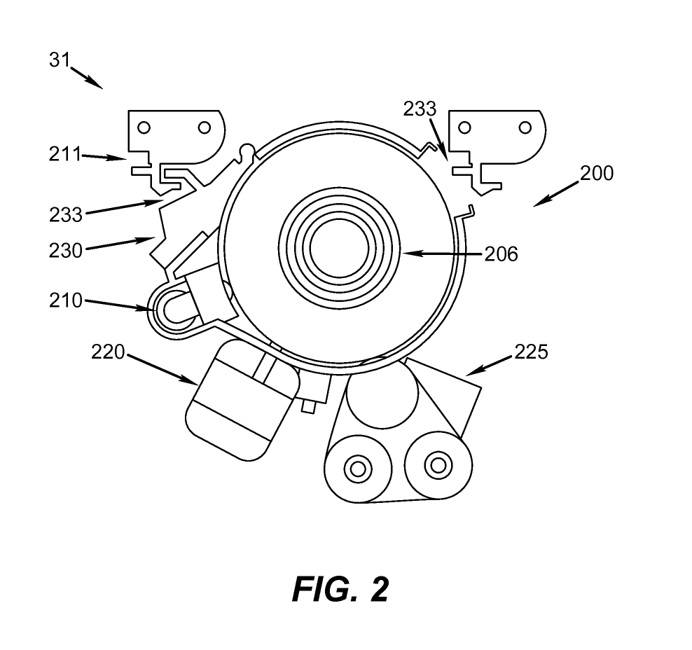

Image writer 220 is used to expose photoreceptor 206 and may be a light emitting diode (LED) array or other similar mechanisms or a laser. Toning unit 225 includes elements 226 and 227 and is used to develop the latent image created by image writer 220 on photoreceptive member 206. Cleaning unit 230, shown in FIG. 2, removes residual or waste toner from photoreceptive member 206 after transfer of the image to a secondary receiver. Other components may be included.

Within the printing module 31, periodic replacement of critical components is necessary to ensure proper function. It may be desirable to cluster multiple components to enable simultaneous replacement. Referring to FIG. 2, one such cluster, referred to as a replacement cartridge 200, consists of a photoreceptive member 206, cleaning unit 230, and charger 210. These components are assembled into a cartridge and held in place with a plastic housing 233.

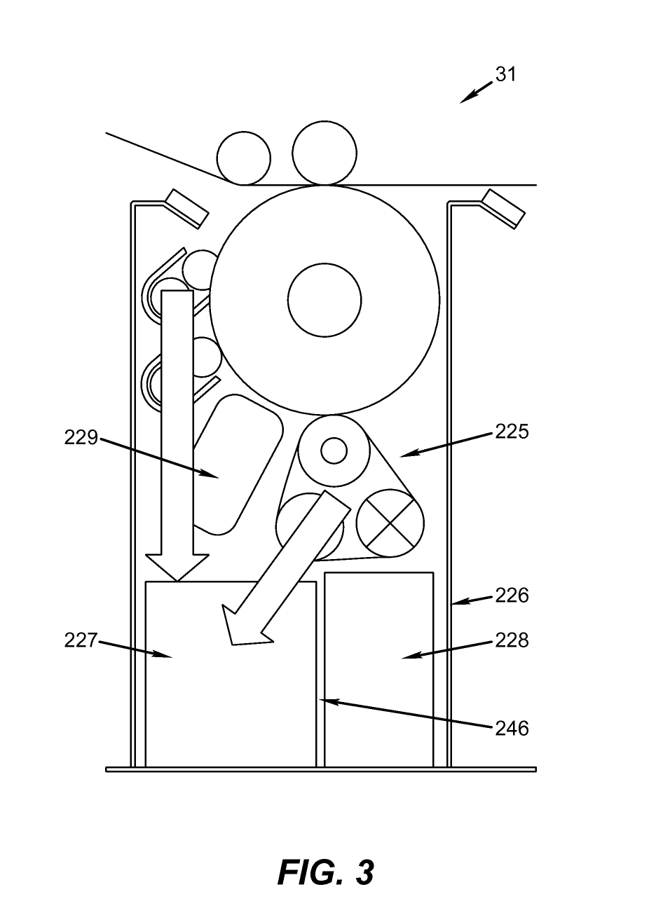

Referring now to FIG. 3 is shown a toning unit 225 which is equipped with a toner sump 226. The toning unit requires periodic replacement. The sump within the toning unit collects unusable toner waste from the toning unit and from the cleaner unit. Unusable toner waste and toning unit life are both dependent upon print volume which enables the size of the sump to be determined. The sump 226 may include two sections. The supply section 228 and the waste section 227. The supply section 228 contains toner suitable for use by the toning unit 225. Waste section 227 is a receptacle for electrophotographic toner waste from the same module which supplies the toner. If the particular design incorporates a toner supply, the life of the toning station may be defined by the volume of toner consumed from the supply section of the sump.

Toner sump 226 connects to toning unit 225 within printing module 31 via waste duct 229. Waste ducts 229 transport residual waste toner from the electrophotographic process scavenged by cleaning unit 230 within replacement cartridge 200 to the toner sump 226. These waste ducts 229 may contain mechanisms for pumping toner, either in the form of an auger or lift mechanism, if necessary, depending upon the location of the toning unit 225.

Typically the ratio of toner waste to toner supply for electrophotographic print modules is very small, therefore the volumes of sections dedicated for supply should be large when compared to waste section. The supply sections 228 and waste section 227 within the toner sump 226 may be separated by a fixed wall thereby providing for a fixed volume of space, or a moveable wall or the separation may be a membrane 246. The use of a moveable wall or membrane allows maximum volume for toner supply. As toner is consumed, the moveable wall or membrane increases waste section 227 volume, allowing space for toner waste. In the case of a membrane, the unfilled space occupied is the volume of the membrane material. As toner is augured into the waste section 227, the chamber volume increases by expanding the membrane.

Similarly, a moveable wall could be used. In this case the wall could be dovetailed or hinged within the toner sump 226. The initial waste section 227 volume is very small. As waste toner is transported into waste section 227, the wall moves, expanding the volume to occupy the required space. An advantage of a moveable wall or membrane is that in the event of a malfunction, where non-typical volumes of waste are produced within the module, the toner sump 226 adapts to the higher waste volume without causing additional malfunction.

The invention has been described in detail with particular reference to certain preferred embodiments thereof, but it will be understood that variations and modifications can be effected within the scope of the invention.

### Parts List

31 printing module

111 photoreceptive member

200 replacement cartridge

206 photoreceptor

210 charging subsystem

211 meter

212 meter

213 grid

220 image writer

225 toning unit

226 toner sump

227 waste section

228 supply section

229 waste duct

230 housing

246 membrane

1. An apparatus for collecting electrophotographic waste comprising:
a toning station containing fresh toner;
an auger for transferring waste toner to the toner station; and
a member for separating waste toner in the toner station from fresh toner.

2. The apparatus of claim 1 wherein a toner supply system provides fresh toner to the toning station.

3. A system for collecting electrophotographic waste from an electrophotographic printer comprising:
a charging subsystem for charging a photoconductor;
an image writer for creating an image on the photoconductor;
a toning unit for developing the image with toner;
an intermediate for transferring the image;
a cleaning unit for removing waste toner from the photoconductor;
an auger for transferring the waste toner to a toner station; and
a member for separating waste toner in the toner station from fresh toner.

4. The apparatus of claim 1 wherein the member is rigid or flexible.

5. The apparatus of claim 1 wherein a toner supply system provides fresh toner to the toning station.
